(19) United States
(12) Patent Application Publication
(10) Pub. No.: US 2019/0184524 A1
(43) Pub. Date: Jun. 20, 2019

(54) POLYCRYSTALLINE DIAMOND CONSTRUCTION & METHOD OF MAKING

(71) Applicant: Element Six Abrasives Holdings Limited, London (GB)

(72) Inventor: Nedret CAN, Oxfordshire (GB)

(21) Appl. No.: 16/038,485

(22) Filed: Jul. 18, 2018

Related U.S. Application Data
(63) Continuation of application No. 14/423,780, filed on Feb. 25, 2015, now abandoned.
(60) Provisional application No. 61/695,817, filed on Aug. 31, 2012.

(30) Foreign Application Priority Data
Aug. 31, 2012 (GB) 1215565.1

(51) Int. Cl. B24D 3/06; B22F 3/14; C04B 35/52; C22C 26/00; E21B 10/567; B24D 18/00

(52) U.S. Cl. CPC B24D 3/06; B22F 3/14; C04B 35/52; B22F 2005/001; E21B 10/567; B24D 18/0009; C22C 26/00

(57) ABSTRACT

A superhard polycrystalline construction comprises a body of polycrystalline superhard material, comprising a mass of superhard grains exhibiting inter-granular bonding and defining a plurality of interstitial regions therebetween, the superhard grains having an associated mean free path and a non-superhard phase at least partially filling a plurality of the interstitial regions and having an associated mean free path. The median of the mean free path associated with the non-superhard phase divided by (Q3−Q1) for the non-superhard phase being greater than or equal to 0.50, where Q1 is the first quartile and Q3 is the third quartile; and the median of the mean free path associated with the superhard grains divided by (Q3−Q1) for the superhard grains being less than 0.60. The body of polycrystalline superhard material has a first surface having a surface topology comprising one or more indentations therein and/or projections therefrom. There is also disclosed a method of forming such a construction.

### FIELD

This disclosure relates to superhard constructions and methods of making such constructions, particularly but not exclusively to constructions comprising polycrystalline diamond (PCD) structures attached to a substrate, and tools comprising the same, particularly but not exclusively for use in rock degradation or drilling, or for boring into the earth in the oil and gas industry.

### BACKGROUND

Polycrystalline diamond (PCD) is an example of a superhard material (also called a superabrasive material) comprising a mass of substantially inter-grown diamond grains, forming a skeletal mass defining interstices between the diamond grains. PCD material typically comprises at least about 80 volume % of diamond and is conventionally made by subjecting an aggregated mass of diamond grains to an ultra-high pressure of greater than about 5 GPa, and temperature of at least about 1,200° C., for example. A material wholly or partly filling the interstices may be referred to as filler or binder material.

PCD is typically formed in the presence of a sintering aid such as cobalt, which promotes the inter-growth of diamond grains. Suitable sintering aids for PCD are also commonly referred to as a solvent-catalyst material for diamond, owing to their function of dissolving, to some extent, the diamond and catalysing its re-precipitation. A solvent-catalyst for diamond is understood be a material that is capable of promoting the growth of diamond or the direct diamond-to-diamond inter-growth between diamond grains at a pressure and temperature condition at which diamond is thermodynamically stable. Consequently the interstices within the sintered PCD product may be wholly or partially filled with residual solvent-catalyst material. Most typically, PCD is often formed on a cobalt-cemented tungsten carbide substrate, which provides a source of cobalt solvent-catalyst for the PCD. Materials that do not promote substantial coherent intergrowth between the diamond grains may themselves form strong bonds with diamond grains, but are not suitable solvent-catalysts for PCD sintering.

Cemented tungsten carbide which may be used to form a suitable substrate is formed from carbide particles being dispersed in a cobalt matrix by mixing tungsten carbide particles/grains and cobalt together then heating to solidify. To form the cutting element with an ultra hard material layer such as PCD or PCBN, diamond particles or grains or CBN grains are placed adjacent the cemented tungsten carbide body in a refractory metal enclosure such as a niobium enclosure and are subjected to high pressure and high temperature so that inter-grain bonding between the diamond grains or CBN grains occurs, forming a polycrystalline ultra hard diamond or polycrystalline CBN layer.

In some instances, the substrate may be fully cured prior to attachment to the ultra hard material layer whereas in other cases, the substrate may be green, that is, not fully cured. In the latter case, the substrate may fully cure during the HTHP sintering process. The substrate may be in powder form and may solidify during the sintering process used to sinter the ultra hard material layer.

PCD material may be used as an abrasive compact in a wide variety of tools for cutting, machining, milling, grinding, drilling or degrading hard or abrasive materials such as rock, metal, ceramics, composites and wood-containing materials. For example, tool inserts comprising PCD material are widely used within drill bits used for boring into the earth in the oil and gas drilling industry. The working life of superhard tool inserts may be limited by fracture of the superhard material, including by spalling and chipping, or by wear of the tool insert.

In many of these applications, the temperature of the PCD material may become elevated as it engages rock or other workpieces or bodies. Mechanical properties of PCD material such as abrasion resistance, hardness and strength tend to deteriorate at elevated temperatures, which may be promoted by the residual catalyst material within the body of PCD material.

Ever increasing drives for improved productivity in the earth boring field place ever increasing demands on the materials used for cutting rock. Specifically, PCD materials with improved abrasion and impact resistance are required to achieve faster cut rates and longer tool life.

Cutting elements or tool inserts comprising PCD material are widely used in drill bits for boring into the earth in the oil and gas drilling industry where rock drilling and other operations require high abrasion resistance and impact resistance. One of the factors limiting the success of the polycrystalline diamond (PCD) abrasive cutters is the generation of heat due to friction between the PCD and the work material. This heat causes the thermal degradation of the diamond layer. The thermal degradation increases the wear rate of the cutter through increased cracking and spalling of the PCD layer as well as back conversion of the diamond to graphite causing increased abrasive wear.

It is desirable to improve the abrasion resistance of a body of PCD material when used as an abrasive compact in tools such as those mentioned above, as this allows extended use of the cutter, drill or machine in which the abrasive compact is located. This is typically achieved by manipulating variables such as average diamond particle/grain size, overall binder content, particle density and the like. Methods used to improve the abrasion resistance of a PCD composite often result in a decrease in impact resistance of the composite.

For example, it is well known in the art to increase the abrasion resistance of an ultrahard composite by reducing the overall grain size of the component ultrahard particles. Typically, however, as these materials are made more wear resistant they become more brittle or prone to fracture.

Abrasive compacts designed for improved wear performance will therefore tend to have poor impact strength or reduced resistance to spalling. This trade-off between the properties of impact resistance and wear resistance makes designing optimised abrasive compact structures, particularly for demanding applications, inherently self-limiting.

Additionally, because finer grained structures will typically contain more solvent/catalyst or metal binder, they tend to exhibit reduced thermal stability when compared to coarser grained structures. This reduction in optimal behaviour for finer grained structures can cause substantial problems in practical applications where the increased wear resistance is nonetheless required for optimal performance.

Prior art methods to solve this problem have typically involved attempting to achieve a compromise by combining the properties of both finer and coarser ultrahard particle grades in various manners within the ultrahard abrasive layer.

Another conventional solution is to remove, typically by acid leaching, the catalyst/solvent or binder phase from the PCD material.

It is typically extremely difficult and time consuming to remove the bulk of a metallic catalyst/solvent effectively from a PCD table, particularly from the thicker PCD tables required by current applications. Achieving appreciable leaching depths can take so long as to be commercially unfeasible or require undesirable interventions such as extreme acid treatment or physical drilling of the PCD tables.

It has further been appreciated that cutters and machine tool cutting inserts having cutting surfaces with shaped topologies may be advantageous in various applications as the surface features may be beneficial in use to divert, for example, chips from the working surface being worked on by the cutter or machine tool, and/or in some instances to act as a chip breaker. Also, such surface topologies may produce demonstrably better surface finish qualities compared to flat surface cutting tool geometries. However, the extreme hardness and abrasion resistance of materials such as PCD or PCBN which are typically used as the cutting element or insert in such applications makes it very difficult and expensive to machine these materials with desired surface topology features that may be used, for example, as chip breakers or to divert the debris generated in use.

There is a need to provide super-hard bodies of polycrystalline material such as inserts for cutting or machine tools having effective performance and to provide a more efficient method for making bodies of polycrystalline materials for use as such cutters or inserts. An abrasive compact that can also achieve improved properties of abrasion resistance, fracture and impact resistance and a method of forming such composites are highly desirable.

### SUMMARY

Viewed from a first aspect there is provided a superhard polycrystalline construction comprising a body of polycrystalline superhard material, comprising:

a mass of superhard grains exhibiting inter-granular bonding and defining a plurality of interstitial regions therebetween, the superhard grains having an associated mean free path; and

a non-superhard phase at least partially filling a plurality of the interstitial regions and having an associated mean free path;

the median of the mean free path associated with the non-superhard phase divided by (Q3−Q1) for the non-superhard phase being greater than or equal to 0.50, where Q1 is the first quartile and Q3 is the third quartile; and the median of the mean free path associated with the superhard grains divided by (Q3−Q1) for the superhard grains being less than 0.60;

wherein the body of polycrystalline superhard material has a first surface having a surface topology comprising one or more indentations therein and/or projections therefrom.

Viewed from a second aspect there is provided a method of forming a superhard polycrystalline construction, comprising:
providing a mass of grains of superhard material; and
treating the pre-sinter assembly in the presence of a catalyst/solvent material for the superhard grains at an ultra-high pressure of around 5.5 GPa or greater and a temperature at which the superhard material is more thermodynamically stable than graphite to sinter together the grains of superhard material to form a polycrystalline superhard construction, the superhard grains exhibiting inter-granular bonding and defining a plurality of interstitial regions therebetween, a non-superhard phase at least partially filling a plurality of the interstitial regions;
wherein:
   the median of the mean free path associated with the non-superhard phase divided by (Q3−Q1) for the non-superhard phase is greater than or equal to 0.50, where Q1 is the first quartile and Q3 is the third quartile of the mean free path measurements associated with the non-superhard phase; and
   the median of the mean free path associated with the superhard grains divided by (Q3−Q1) for the superhard grains is less than 0.60, where Q1 is the first quartile and Q3 is the third quartile of the mean free path measurements associated with the superhard grains; and
   the method further comprising forming a non-planar surface topology in a first surface of the body of polycrystalline diamond material, the surface topology comprising one or more indentations in and/or projections extending from the first surface.

### BRIEF DESCRIPTION OF DRAWINGS

Non-limiting embodiments will now be described by way of example and with reference to the accompanying drawings in which:

FIG. 1 is a schematic drawing of the microstructure of a body of PCD material; and

FIG. 2 is a schematic drawing of a PCD compact comprising a PCD structure bonded to a substrate.

### DETAILED DESCRIPTION

As used herein, “polycrystalline diamond” (PCD) material comprises a mass of diamond grains, a substantial portion of which are directly inter-bonded with each other and in which the content of diamond is at least about 80 volume percent of the material. In one embodiment of PCD material, interstices between the diamond gains may be at least partly filled with a binder material comprising a catalyst for diamond. As used herein, “interstices” or “interstitial regions” are regions between the diamond grains of PCD material. In embodiments of PCD material, interstices or interstitial regions may be substantially or partially filled with a material other than diamond, or they may be substantially empty. Embodiments of PCD material may comprise at least a region from which catalyst material has been removed from the interstices, leaving interstitial voids between the diamond grains.

As used herein, a “PCD structure” comprises a body of PCD material.

As used herein, a “metallic” material is understood to comprise a metal in unalloyed or alloyed form and which has characteristic properties of a metal, such as high electrical conductivity.

As used herein, “catalyst material” for diamond, which may also be referred to as solvent/catalyst material for diamond, means a material that is capable of promoting the growth of diamond or the direct diamond-to-diamond inter-growth between diamond grains at a pressure and temperature condition at which diamond is thermodynamically stable.

A filler or binder material is understood to mean a material that wholly or partially fills pores, interstices or interstitial regions within a polycrystalline structure.

A multi-modal size distribution of a mass of grains is understood to mean that the grains have a size distribution with more than one peak, each peak corresponding to a respective “mode”. Multimodal polycrystalline bodies may be made by providing more than one source of a plurality of grains, each source comprising grains having a substantially different average size, and blending together the grains or particles from the sources. In one embodiment, the PCD structure may comprise diamond grains having a multimodal distribution.

As used herein, the term ‘total binder area’ is expressed as the percentage of non-diamond phase(s) in the total cross-sectional area of a polished cross section of the body of PCD material being analysed.

As used herein, a “superhard material” is a material having a Vickers hardness of at least about 28 GPa. Diamond and cubic boron nitride (cBN) material are examples of superhard materials.

As used herein, a “superhard construction” means a construction comprising a body of polycrystalline superhard material. In such a construction, a substrate may be attached thereto or alternatively the body of polycrystalline material may be free-standing and unbacked.

As used herein, PCBN (polycrystalline cubic boron nitride) material refers to a type of superhard material comprising grains of cubic boron nitride (cBN) dispersed within a matrix comprising metal or ceramic. PCBN is an example of a superhard material.

The term “substrate” as used herein means any substrate over which the ultra hard material layer is formed. For example, a “substrate” as used herein may be a transition layer formed over another substrate. Additionally, as used herein, the terms “radial” and “circumferential” and like terms are not meant to limit the feature being described to a perfect circle.

As used herein, the term “integrally formed” regions or parts are produced contiguous with each other and are not separated by a different kind of material.

Like reference numbers are used to identify like features in all drawings.

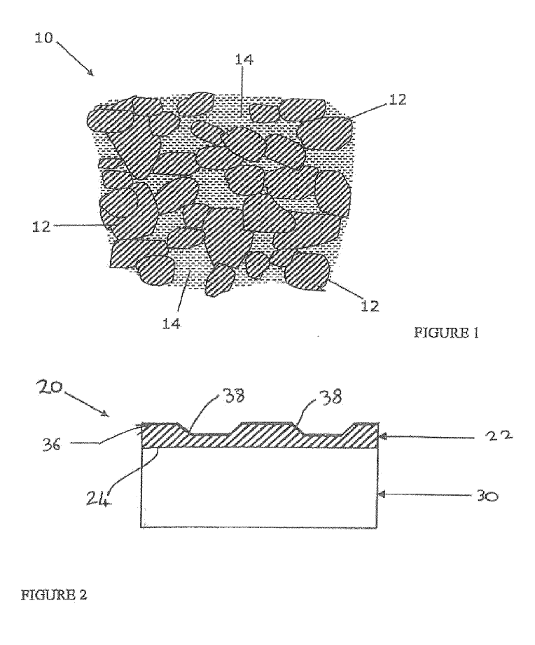

With reference to FIG. 1, a body of PCD material 10 comprises a mass of directly inter-bonded grains of superhard material 12 and interstices 14 between the grains 12, which may be at least partly filled with filler or binder material. FIG. 2 shows an embodiment of a superhard composite compact 20 for use as a cutter comprising a body of superhard material 22 integrally bonded at an interface 24 to a substrate 30. The substrate 30 may be formed of, for example, cemented carbide material and may be, for example, cemented tungsten carbide, cemented tantalum carbide, cemented titanium carbide, cemented molybdenum carbide or mixtures thereof. The binder metal for such carbides may be, for example, nickel, cobalt, chromium, iron or an alloy containing one or more of these metals. Typically, this binder will be present in an amount of 10 to 20 mass %, but this may be as low as 6 mass % or less. Some of the binder metal may infiltrate the body of polycrystalline superhard material 22 during formation of the compact 20.

The compact 20 of FIG. 2 may, in use, be attached to a drill bit (not shown) for oil and gas drilling operations. The body of superhard material 10 has a free exposed surface 36, which is the surface which, along with its edge, performs the cutting in use. This surface has a non-planar surface topology 38 with surface features extending from and/or into the free surface. In embodiments where the compact 20 is to be used as a cutter, for example for drilling in the oil and gas industry, the surface topology may be used to direct or divert the rock or earth away from the drill bit to which the cutter is attached. Alternatively or additionally, the surface topology may act as a chip breaker suitable for controlling aspects of the size and shape of chips formed when the body of polycrystalline superhard material is used, for example, as a cutter or as an insert for a machine tool to machine a workpiece. Such topology may include depression and/or protrusion features, such as radial or peripheral ridges and troughs, formed on a rake surface of the insert.

An example of a method for producing the PCD compact 20 comprising the body of PCD material 22, as shown in FIGS. 1 and 2, is now described.

In some embodiments, the body of superhard material 22 may include, for example, one or more of nanodiamond additions in the form of nanodiamond powder up to 20 wt %, salt systems, borides, metal carbides of Ti, V, Nb or any of the metals Pd or Ni.

The grains of superhard material may be for example diamond grains or particles. In the starting mixture prior to sintering they may be, for example, bimodal, that is, the feed comprises a mixture of a coarse fraction of diamond grains and a fine fraction of diamond grains. In some embodiments, the coarse fraction may have, for example, an average particle/grain size ranging from about 10 to 60 microns. By “average particle or grain size” it is meant that the individual particles/grains have a range of sizes with the mean particle/grain size representing the “average”. The average particle/grain size of the fine fraction is less than the size of the coarse fraction, for example between around 1/10 to 6/10 of the size of the coarse fraction, and may, in some embodiments, range for example between about 0.1 to 20 microns.

In some embodiments, the weight ratio of the coarse diamond fraction to the fine diamond fraction ranges from about 50% to about 97% coarse diamond and the weight ratio of the fine diamond fraction may be from about 3% to about 50%. In other embodiments, the weight ratio of the coarse fraction to the fine fraction will range from about 70:30 to about 90:10.

In further embodiments, the weight ratio of the coarse fraction to the fine fraction may range for example from about 60:40 to about 80:20.

In some embodiments, the particle size distributions of the coarse and fine fractions do not overlap and in some embodiments the different size components of the compact are separated by an order of magnitude between the separate size fractions making up the multimodal distribution.

The embodiments consist of at least a wide bi-modal size distribution between the coarse and fine fractions of superhard material, but some embodiments may include three or even four or more size modes which may, for example, be separated in size by an order of magnitude, for example, a blend of particle sizes whose average particle size is 20 microns, 2 microns, 200 nm and 20 nm.

Sizing of diamond particles/grains into fine fraction, coarse fraction, or other sizes in between, may be through known processes such as jet-milling of larger diamond grains and the like.

In embodiments where the superhard material is polycrystalline diamond material, the diamond grains used to form the polycrystalline diamond material may be natural or synthetic.

In some embodiments, the binder catalyst/solvent may comprise cobalt or some other iron group elements, such as iron or nickel, or an alloy thereof. Carbides, nitrides, borides, and oxides of the metals of Groups IV-VI in the periodic table are other examples of non-diamond material that might be added to the sinter mix. In some embodiments, the binder/catalyst/sintering aid may be Co.

The cemented metal carbide substrate may be conventional in composition and, thus, may be include any of the Group IVB, VB, or VIB metals, which are pressed and sintered in the presence of a binder of cobalt, nickel or iron, or alloys thereof. In some embodiments, the metal carbide is tungsten carbide.

In some embodiments, both the bodies of, for example, diamond and carbide material plus sintering aid/binder/catalyst are applied as powders and are sintered simultaneously in a single UHP/HT process. The diamond grains and mass of carbide to form the substrate are placed in an HP/HT reaction cell assembly and subjected to HP/HT processing. The HP/HT processing conditions selected are sufficient to effect intercrystalline bonding between adjacent grains of abrasive particles and, optionally, the joining of sintered particles to the cemented metal carbide support. In one embodiment, the processing conditions generally involve the imposition for about 3 to 120 minutes of a temperature of at least about 1200 degrees C. and an ultra-high pressure of greater than about 5 GPa.

In some embodiments, the substrate may be pre-sintered in a separate process before being bonded together in the HP/HT press during sintering of the ultrahard polycrystalline material.

In a further embodiment, both the substrate and a body of polycrystalline superhard material are pre-formed. For example, the bimodal or multimodal feed of ultrahard grains/particles with optional carbonate binder-catalyst also in powdered form are mixed together, and the mixture is packed into an appropriately shaped canister and is then subjected to extremely high pressure and temperature in a press. Typically, the pressure is at least 5 GPa and the temperature is at least around 1200 degrees C. The preformed body of polycrystalline superhard material is then placed in the appropriate position on the upper surface of the preform carbide substrate (incorporating a binder catalyst), and the assembly is located in a suitably shaped canister. The assembly is then subjected to high temperature and pressure in a press, the order of temperature and pressure being again, at least around 1200 degrees C. and 5 GPa respectively. During this process the solvent/catalyst migrates from the substrate into the body of superhard material and acts as a binder-catalyst to effect intergrowth in the layer and also serves to bond the layer of polycrystalline superhard material to the substrate. The sintering process also serves to bond the body of superhard polycrystalline material to the substrate.

A support body comprising cemented carbide in which the cement or binder material comprises a catalyst material for diamond, such as cobalt, may be provided. The support body may have a non-planar end or a substantially planar proximate end on which the PCD structure is to be formed and which forms the interface 24. A non-planar shape of the end may be configured to reduce undesirable residual stress between the PCD structure 22 and the support body 30. A cup may be provided for use in assembling the diamond-containing sheets onto the support body. The first and second sets of discs may be stacked into the bottom of the cup. In one version of the method, a layer of substantially loose diamond grains may be packed onto the uppermost of the discs. The support body may then be inserted into the cup with the proximate end going in first and pushed against the substantially loose diamond grains, causing them to move slightly and position themselves according to the shape of the non-planar end of the support body to form a pre-sinter assembly.

The pre-sinter assembly may be placed into a capsule for an ultra-high pressure press and subjected to an ultra-high pressure of at least about 5.5 GPa and a high temperature of at least about 1,300 degrees centigrade to sinter the diamond grains and form a PCD element comprising a PCD structure integrally joined to the support body. In one version of the method, when the pre-sinter assembly is treated at the ultra-high pressure and high temperature, the binder material within the support body melts and infiltrates the strata of diamond grains. The presence of the molten catalyst material from the support body is likely to promote the sintering of the diamond grains by intergrowth with each other to form an integral, stratified PCD structure.

In some versions of the method, the aggregate masses may comprise substantially loose diamond grains, or diamond grains held together by a binder material. The aggregate masses of multimodal grains may be in the form of granules, discs, wafers or sheets, and may contain catalyst material for diamond and/or additives for reducing abnormal diamond grain growth, for example, or the aggregated mass may be substantially free of catalyst material or additives. In some embodiments, the aggregate masses may be assembled onto a cemented carbide support body.

In some embodiments, the pre-sinter assembly may be subjected to a pressure of at least about 6 GPa, at least about 6.5 GPa, at least about 7 GPa or even at least about 7.5 GPa.

The one or more indentations in and/or projections 38 from the free cutting surface 36 of the body of PCD material 22 may be formed during the sintering process or may, for example, be formed post-sintering using techniques such as electrical discharge machining (EDM) or laser ablation to achieve the desired surface topology to suit the application in which the compact is to be employed.

An example method of forming the shaped surface topology during the sintering process is set out below.

The aggregated mass of grains of diamond material is placed into a canister, and a ceramic punch or layer formed of a ceramic material which does not react chemically with the diamond material is placed in contact with the aggregated mass of grains of diamond material, the ceramic layer having a surface with surface topology. The ceramic material may additionally or alternatively be such that it does not react chemically with the sinter catalyst material used to bond the diamond grains to one another during sintering. In some embodiments, the surface topology of the ceramic material is placed in direct contact with the diamond grains to imprint a pattern therein complementary to the surface topology. In other embodiments, the ceramic material may be in indirect contact with the grains, being spaced therefrom by a thin layer or a coating to assist in post sintering separation of the ceramic material from the sintered superhard diamond material. In such cases, any coating or additional layer is also formed of a material that does not react chemically with the superhard material and/or the sinter catalyst material. The aggregated mass of diamond grains and ceramic layer are then subjected to an ultra-high pressure of at least about 5.5 GPa and a temperature of at least about 1,250 degrees centigrade to melt the cobalt comprised in the substrate body and sinter the diamond grains to each other to form a body of polycrystalline superhard material having a surface topology complementary to the surface topology of the ceramic layer. The ceramic layer is then removed from the body of polycrystalline material for example by impact.

The ceramic layer may be easily removed from the body of polycrystalline material as there is no chemical reaction with the ceramic material enabling easy separation of the two bodies. Any residual ceramic may be removed by a light sand blast, resulting in a good, semi-polished surface finish. The ceramic materials that may be used to create the surface topology in the superhard material may include, for example, the group of oxide ceramic materials that are not reduced by carbo-thermal reaction, including Magnesia, Calcia, Zirconia, Alumina.

As mentioned above, in some embodiments, the surface topology of the ceramic material may be coated with a layer which directly contacts the grains prior to sintering and which is of a composition such that it facilitates removal of the ceramic body from the sintered body of polycrystalline superhard material. Examples of such a coating may include zirconia, alumina, calcium carbonate or calcium oxide.

In alternative embodiments, the ceramic material directly contacts the grains of polycrystalline superhard material to be sintered.

The step of placing the grains of superhard material into the canister may, in some embodiments, comprise providing a plurality of sheets comprising the grains and stacking the sheets in the canister to form the aggregation of superhard grains. In other embodiments, the grains of superhard material may be deposited into the canister using sedimentation or electrophoretic deposition techniques.

In some embodiments, the ceramic material may be formed, for example, of any one or more of the group of oxide ceramic materials that are not reduced by carbo-thermal reaction in contact with the grains. An example of such materials may include any one or more of the group of oxide ceramic materials comprising oxides of magnesia, calcia, zirconia, and/or alumina.

The steps of placing the materials in the canister may be reversed or their order changed, for example, the step of placing the ceramic layer in contact with the aggregated mass of grains may be after the step of placing the grains into a canister. Alternatively, the ceramic layer may be placed into the canister before the grains are placed in the canister.

The body of polycrystalline diamond material formed by this method may have a free outer surface 36, on removal of the ceramic layer therefrom, which is of the same quality as the bulk of the body of polycrystalline material. This is in contrast, for example, to conventionally formed PCD in which the PCD layer in direct contact with the canister material used during sintering is usually of an inferior quality compared to the bulk PCD due to an interaction between the diamond, cobalt binder and canister material. Thus, in conventional PCD cutters, it is usually necessary to remove the top surface by grinding, sandblasting or other methods. Such steps are not required in PCD formed according to one or more embodiments as the body of polycrystalline superhard material has a surface topology on a first surface, the first surface being substantially free of material from a canister used in formation of the body of polycrystalline superhard material.

The surface topology of the ceramic material may be designed according to the requirements of a given application of the polycrystalline body and having regard to the intended shape of the body depending on its ultimate use. For example, in some embodiments the surface topology of the ceramic material is constructed to impart a chamfered edge to the body of polycrystalline superhard material during sintering.

In some embodiments, such as those illustrated in FIG. 2, the body of PCD material 22 may be formed on a substrate 30, the substrate being placed into the canister prior to sintering, the body of polycrystalline superhard material 22 bonding to the substrate 30 during sintering along an interface therebetween. The interface 24 may be substantially planar, such as shown in FIG. 2, or it may be substantially non-planar.

The substrate 30 may, for example, be formed of cemented carbide material. In some embodiments, the sintered body may have a thickness of up to around 6000 microns.

After forming the body of sintered polycrystalline material, a finishing treatment may be applied to treat the body of super-hard material 22 to remove sinter catalyst from at least some of the interstices between the inter-bonded grains. In particular, catalyst material may be removed from a region of the PCD structure 22 adjacent the working surface or the side surface or both the working surface and the side surface. This may be done by treating the PCD structure 22 with acid to leach out catalyst material from between the diamond grains, or by other methods such as electrochemical methods. A thermally stable region, which may be substantially porous, extending a depth of at least about 50 microns or at least about 100 microns from a surface of the PCD structure 22, may thus be provided. Some embodiments with 50 to 80 micron thick layers in which this leach depth is around 250 microns have been shown to exhibit substantially improved performance, for example a doubling in performance after leaching over an unleached PCD product. In one example, the substantially porous region may comprise at most 2 weight percent of catalyst material.

In embodiments where the cemented carbide substrate does not contain sufficient solvent/catalyst for diamond, and where the PCD structure is integrally formed onto the substrate during sintering at an ultra-high pressure, solvent/catalyst material may be included or introduced into the aggregated mass of diamond grains from a source of the material other than the cemented carbide substrate. The solvent/catalyst material may comprise cobalt that infiltrates from the substrate in to the aggregated mass of diamond grains just prior to and during the sintering step at an ultra-high pressure. However, in embodiments where the content of cobalt or other solvent/catalyst material in the substrate is low, particularly when it is less than about 11 weight percent of the cemented carbide material, then an alternative source may need to be provided in order to ensure good sintering of the aggregated mass to form PCD.

Solvent/catalyst for diamond may be introduced into the aggregated mass of diamond grains by various methods, including blending solvent/catalyst material in powder form with the diamond grains, depositing solvent/catalyst material onto surfaces of the diamond grains, or infiltrating solvent/catalyst material into the aggregated mass from a source of the material other than the substrate, either prior to the sintering step or as part of the sintering step. Methods of depositing solvent/catalyst for diamond, such as cobalt, onto surfaces of diamond grains are well known in the art, and include chemical vapour deposition (CVD), physical vapour deposition (PVD), sputter coating, electrochemical methods, electroless coating methods and atomic layer deposition (ALD). It will be appreciated that the advantages and disadvantages of each depend on the nature of the sintering aid material and coating structure to be deposited, and on characteristics of the grain.

In one embodiment, cobalt may be deposited onto surfaces of the diamond grains by first depositing a pre-cursor material and then converting the precursor material to a material that comprises elemental metallic cobalt. For example, in the first step cobalt carbonate may be deposited on the diamond grain surfaces using the following reaction:

Co(NO₃)₂+Na₂CO₃->CoCO₃+2NaNO₃

The deposition of the carbonate or other precursor for cobalt or other solvent/catalyst for diamond may be achieved by means of a method described in PCT patent publication number WO/2006/032982. The cobalt carbonate may then be converted into cobalt and water, for example, by means of pyrolysis reactions such as the following:

CoCO₃->COO+CO₂

COO+H₂->CO+H₂O

In another embodiment, cobalt powder or precursor to cobalt, such as cobalt carbonate, may be blended with the diamond grains. Where a precursor to a solvent/catalyst such as cobalt is used, it may be necessary to heat treat the material in order to effect a reaction to produce the solvent/catalyst material in elemental form before sintering the aggregated mass.

As described above, to assist in improving thermal stability of the sintered structure, the catalysing material may be removed from a region of the polycrystalline layer adjacent an exposed surface thereof. Generally, that surface will be on a side of the polycrystalline layer opposite to the substrate and will provide a working surface for the polycrystalline diamond layer. Removal of the catalysing material may be carried out using methods known in the art such as electrolytic etching, and acid leaching and evaporation techniques.

It has been found that multimodal distributions of some embodiments may assist in achieving a very high degree of diamond intergrowth while still maintaining sufficient open porosity to enable efficient leaching.

Polycrystalline bodies formed according to the above-described method may have many applications. For example, they may be used as an insert for a machine tool, in which the cutter structure comprises the body of polycrystalline superhard material according to one or more embodiments and the surface topology of the polycrystalline material in such an application may be used as a chip-breaker. In such inserts, the cutter structure which may be joined to an insert base, may have, for example, a mean thickness of at least 100 microns, and in some embodiments, a mean thickness of at most 1,000 microns.

Embodiments are described in more detail below with reference to the following examples which are provided herein by way of illustration only and are not intended to be limiting.

### Example 1

This non-limiting example illustrates a method of forming the surface topology during the sintering process.

A surface topology configuration may be designed according to the requirements of a given drilling or machining application and having regard to the intended shape of a cutter structure or machine tool insert. A cobalt-cemented carbide substrate body may be provided and a ceramic plug may be provided, the ceramic plug having a surface comprising a surface topology that is complementary (i.e. inverse) to that of the desired surface topology for the cutter or machine tool insert. A pre-compact assembly may be prepared by forming a plurality of diamond grains into an aggregation against the surface of the substrate, and encapsulating the assembly within a jacket, formed for example of alumina or other ceramic material. The surface of the ceramic plug having the desired surface topology to be imparted to the diamond body on sintering is placed in contact with the diamond grains. The pre-compact assembly is subjected to an ultra-high pressure of at least about 5.5 GPa and a temperature of at least about 1,250 degrees centigrade to melt the cobalt comprised in the substrate body and sinter the diamond grains to each other to form a composite compact comprising a PCD structure formed joined to the substrate. After sintering, the ceramic plug may be removed from the sintered PCD material by, for example, light impact and the PCD structure may be treated in acid to remove residual cobalt within interstitial regions between the inter-grown diamond grains. Removal of a substantial amount of cobalt from the PCD structure is likely to increase substantially the thermal stability of the PCD structure and will likely reduce the risk of degradation of the PCD material. The composite compact thus formed may be further processed, depending on its intended application. For example, if it is to be used as a machine tool insert, it may be further treated by grinding to provide a machine tool insert comprising the PCD cutter structure having well-defined chip-breaker features.

### Example 2

A quantity of sub-micron cobalt powder sufficient to obtain 2 mass % in the final diamond mixture was initially de-agglomerated in a methanol slurry in a ball mill with WC milling media for 1 hour. A fine fraction of diamond powder with an average grain size of 2 □m was then added to the slurry in an amount to obtain 10 mass % in the final mixture. Additional milling media was introduced and further methanol was added to obtain suitable slurry; and this was milled for a further hour. A coarse fraction of diamond, with an average grain size of approximately 20 □m was then added in an amount to obtain 88 mass % in the final mixture. The slurry was again supplemented with further methanol and milling media, and then milled for a further 2 hours. The slurry was removed from the ball mill and dried to obtain the diamond powder mixture.

The diamond powder mixture was then placed into a suitable HpHT vessel, adjacent to a tungsten carbide substrate and sintered at a pressure of around 6.8 GPa and a temperature of about 1500 □C.

The surface topology 38 in the cutting surface 36 of the PCD body 22 was formed post sintering using EDM techniques. In other embodiments, the surface topology could have been formed during sintering using, for example, the techniques described above in example 1.

### Example 3

A quantity of sub-micron cobalt powder sufficient to obtain 2.4 mass % in the final diamond mixture was initially de-agglomerated in a methanol slurry in a ball mill with WC milling media for 1 hour. A fine fraction of diamond powder with an average grain size of 2 □m was then added to the slurry in an amount to obtain 29.3 mass % in the final mixture. Additional milling media was introduced and further methanol was added to obtain a suitable slurry; and this was milled for a further hour. A coarse fraction of diamond, with an average grain size of approximately 20 □m was then added in an amount to obtain 68.3 mass % in the final mixture. The slurry was again supplemented with further methanol and milling media, and then milled for a further 2 hours. The slurry was removed from the ball mill and dried to obtain the diamond powder mixture.

The diamond content of the sintered diamond structure is greater than 90 vol % and the coarsest fraction of the distribution may, in some embodiments, be greater than 60 weight % or greater than weight 70%.

The surface topology 38 in the cutting surface 36 of the PCD body 22 was formed post sintering using EDM techniques. In other embodiments, the surface topology could have been formed during sintering using, for example, the techniques described above in example 1.

The surface topology of the ceramic material may be designed according to the requirements of a given application of the polycrystalline body and having regard to the intended shape of the body depending on its ultimate use. For example, in some embodiments the surface topology of the ceramic material is constructed to impart a chamfered edge to the body of polycrystalline superhard material during sintering.

In some embodiments, the polycrystalline bodies formed according to the above-described methods may be used as a cutter for boring into the earth, or as a PCD element for a rotary shear bit for boring into the earth, or for a percussion drill bit or for a pick for mining or asphalt degradation. Alternatively, a drill bit or a component of a drill bit for boring into the earth, may comprise the body of polycrystalline superhard material according to any one or more embodiments.

In polycrystalline diamond material, individual diamond particles/grains are, to a large extent, bonded to adjacent particles/grains through diamond bridges or necks. The individual diamond particles/grains retain their identity, or generally have different orientations. The average grain/particle size of these individual diamond grains/particles may be determined using image analysis techniques. Images are collected on a scanning electron microscope and are analysed using standard image analysis techniques. From these images, it is possible to extract a representative diamond particle/grain size distribution.

Generally, the body of polycrystalline diamond material will be produced and bonded to the cemented carbide substrate in a HPHT process. In so doing, it is advantageous for the binder phase and diamond particles to be arranged such that the binder phase is distributed homogeneously and is of a fine scale.

A cross-section through the PCD structure was then examined micro-structurally by means of a scanning electron microscope (SEM).

The homogeneity or uniformity of the sintered structure is defined by conducting a statistical evaluation of a large number of collected images. The distribution of the binder phase, which is easily distinguishable from that of the diamond phase using electron microscopy, can then be measured in a method similar to that disclosed in EP 0974566. This method allows a statistical evaluation of the average thicknesses of the binder phase along several arbitrarily drawn lines through the microstructure. This binder thickness measurement is also referred to as the “mean free path” by those skilled in the art. For two materials of similar overall composition or binder content and average diamond grain size, the material which has the smaller average thickness will tend to be more homogenous, as this implies a “finer scale” distribution of the binder in the diamond phase. In addition, the smaller the standard deviation of this measurement, the more homogenous is the structure. A large standard deviation implies that the binder thickness varies widely over the microstructure, i.e. that the structure is not even, but contains widely dissimilar structure types.

The binder and diamond mean free path measurements were obtained for various samples in the manner set out below. Unless otherwise stated herein, dimensions of mean free path within the body of PCD material refer to the dimensions as measured on a surface of, or a section through, a body comprising PCD material and no stereographic correction has been applied. For example, the measurements are made by means of image analysis carried out on a polished surface, and a Saltykov correction has not been applied in the data stated herein.

In measuring the mean value of a quantity or other statistical parameter measured by means of image analysis, several images of different parts of a surface or section (hereinafter referred to as samples) are used to enhance the reliability and accuracy of the statistics. The number of images used to measure a given quantity or parameter may be, for example between 10 to 30. If the analysed sample is uniform, which is the case for PCD, depending on magnification, 10 to 20 images may be considered to represent that sample sufficiently well.

The resolution of the images needs to be sufficiently high for the inter-grain and inter-phase boundaries to be clearly made out and, for the measurements stated herein an image area of 1280 by 960 pixels was used. Images used for the image analysis were obtained by means of scanning electron micrographs (SEM) taken using a backscattered electron signal. The back-scatter mode was chosen so as to provide high contrast based on different atomic numbers and to reduce sensitivity to surface damage (as compared with the secondary electron imaging mode).
1. A sample piece of the PCD sintered body is cut using wire EDM and polished. At least 10 back scatter electron images of the surface of the sample are taken using a Scanning Electron Microscope at 1000 times magnifications.
2. The original image was converted to a greyscale image. The image contrast level was set by ensuring the diamond peak intensity in the grey scale histogram image occurred between 10 and 20.
3. An auto threshold feature was used to binarise the image and specifically to obtain clear resolution of the diamond and binder phases.
4. The software, having the trade name analySIS Pro from Soft Imaging System® GmbH (a trademark of Olympus Soft Imaging Solutions GmbH) was used and excluded from the analysis any particles which touched the boundaries of the image. This required appropriate choice of the image magnification:
a. If too low then resolution of fine particles is reduced.
b. If too high then:
i. Efficiency of coarse grain separation is reduced.
ii. High numbers of coarse grains are cut by the boarders of the image and hence less of these grains are analysed.
iii. Thus more images must be analysed to get a statistically-meaningful result.
5. Each particle was finally represented by the number of continuous pixels of which it is formed.
6. The AnalySIS software programme proceeded to detect and analyse each particle in the image. This was automatically repeated for several images.
7. Ten SEM images were analyzed using the grey-scale to identify the binderpools as distinct from the other phases within the sample. The threshold value for the SEM was then determined by selecting a maximum value for binder pools content which only identifies binder pools and excludes all other phases (whether grey or white). Once this threshold value is identified it is used to binarize the SEM image.)
8. One pixel thick lines were superimposed across the width of the binarized image, with each line being five pixels apart (to ensure the measurement is sufficiently representative in statistical terms). Binder phase that are cut by image boundaries were excluded in these measurements.
9. The distance between the binder pools along the superimposed lines were measured and recorded—at least 10,000 measurements were made per material being analysed. Median values were reported for both the non-diamond phase mean free paths and diamond phase mean free paths.
The distance between the binder pools along the superimposed lines were measured and recorded—at least 10,000 measurements were made per material being analysed. The median value for the non-diamond phase mean free paths and the diamond phase mean free paths were calculated. The term “median” in this context is considered to have its conventional meaning, namely the numerical value separating the higher half of the data sample from the lower half.

Also recorded were the mean free path measurements at Q1 and Q3 for both the diamond and non-diamond phases.

Q1 is typically referred to as the first quartile (also called the lower quartile) and is the number below which lies the 25 percent of the bottom data. Q3 is typically referred to as the third quartile (also called the upper quartile) has 75 percent of the data below it and the top 25 percent of the data above it.

From this, it was determined that embodiments have:

alpha >=0.50 and beta <0.60,

where

alpha is the non-diamond phase MFP median/(Q3−Q1), which gives a measure of “uniform binder pool size”; and

beta=diamond MFP median/(Q3−Q1) which gives a measure of “wide grain size distribution”

In some embodiments it was determined that alpha >=0.83 and beta<0.47.

While various embodiments have been described with reference to a number of examples, those skilled in the art will understand that various changes may be made and equivalents may be substituted for elements thereof and that these examples are not intended to limit the particular embodiments disclosed. Various example arrangements and combinations for cutter structures and inserts are envisaged by the disclosure. The cutter structure may comprise natural or synthetic diamond material. Examples of diamond material include polycrystalline diamond (PCD) material, thermally stable PCD material, crystalline diamond material, diamond material made by means of a chemical vapour deposition (CVD) method or silicon carbide bonded diamond.

Furthermore, the cutter structure described herein with reference to one or more embodiments may be used as as part of an insert for a machine tool, comprising the cutter structure with the superhard polycrystalline construction described herein joined to an insert base, the surface topology being formed on a first face of the body of polycrystalline superhard material, the first surface forming a rake face or a cutting face, and the surface topology of the first surface forming chip-breaker topology.

In one or more other embodiments, the superhard polycrystalline structure described herein may form a PCD element for one or more of a rotary shear bit for boring into the earth, a percussion drill bit, or a pick for mining or asphalt degradation.

What is claimed is:

1. A superhard polycrystalline construction comprising a body of polycrystalline superhard material, comprising:
a mass of superhard grains exhibiting inter-granular bonding and defining a plurality of interstitial regions therebetween, the superhard grains having an associated mean free path; and
a non-superhard phase at least partially filling a plurality of the interstitial regions and having an associated mean free path;
the median of the mean free path associated with the non-superhard phase divided by (Q3−Q1) for the non-superhard phase being greater than or equal to 0.50, where Q1 is the first quartile and Q3 is the third quartile; and
the median of the mean free path associated with the superhard grains divided by (Q3−Q1) for the superhard grains being less than 0.60;
wherein the body of polycrystalline superhard material has a first surface having a surface topology comprising one or more indentations therein and/or projections therefrom.

2. A superhard polycrystalline construction according to claim 1, wherein the superhard grains comprise natural and/or synthetic diamond grains, the superhard polycrystalline construction forming a polycrystalline diamond construction.

3. A superhard polycrystalline construction according to claim 1, wherein the non-superhard phase comprises a binder phase.

4. A superhard polycrystalline construction according to claim 3, wherein the binder phase comprises cobalt, and/or one or more other iron group elements, or an alloy thereof, and/or one or more carbides, nitrides, borides, and oxides of the metals of Groups IV-VI in the periodic table.

5. A superhard polycrystalline construction according to claim 4, wherein the one or more other iron group elements comprises iron or nickel.

6.-8. (canceled)

9. A superhard polycrystalline construction according to claim 1, wherein the polycrystalline construction comprises one or more of:
up to 20 wt % nanodiamond additions in the form of nanodiamond powder grains;
salts;
borides or metal carbides of at least one of Ti, V, or Nb; or
at least one of the metals Pd or Ni.

10. A superhard polycrystalline construction as claimed in claim 1, wherein at least a portion of the body of polycrystalline superhard material is substantially free of a catalyst material for diamond, said portion forming a thermally stable region.

11. A superhard polycrystalline construction as claimed in claim 10, wherein the thermally stable region extends a depth of at least 50 microns from a surface of the body of polycrystalline superhard material.

12. A superhard polycrystalline construction as claimed in claim 10, wherein the thermally stable region comprising at most 2 weight percent of catalyst material for diamond.

13. (canceled)

14. A superhard polycrystalline construction as claimed in claim 1, wherein the median of the mean free path associated with the non-superhard phase divided by (Q3−Q1) for the non-superhard phase being greater than or equal to 0.83.

15. A superhard polycrystalline construction as claimed in claim 1, wherein the median of the mean free path associated with the superhard grains divided by (Q3−Q1) for the superhard grains is less than 0.47.

16. A superhard polycrystalline construction according to claim 1, wherein the first surface is substantially free of material from a canister used in formation of the body of polycrystalline superhard material.

17. The polycrystalline superhard construction according to claim 16, wherein the first surface is of the same quality as the bulk of the body of polycrystalline superhard material.

18.-22. (canceled)

23. An insert for a machine tool, comprising a cutter structure joined to an insert base, the cutter structure comprising the polycrystalline superhard construction as claimed in claim 1, the surface topology being formed on a first face of the body of polycrystalline superhard material, the first surface forming a rake face or a cutting face, and the surface topology of the first surface forming chip-breaker topology.

24.-25. (canceled)

26. A method of forming a superhard polycrystalline construction, comprising:
providing a mass of grains of superhard material; and
treating the pre-sinter assembly in the presence of a catalyst/solvent material for the superhard grains at an ultra-high pressure of around 5.5 GPa or greater and a temperature at which the superhard material is more thermodynamically stable than graphite to sinter together the grains of superhard material to form a polycrystalline superhard construction, the superhard grains exhibiting inter-granular bonding and defining a plurality of interstitial regions therebetween, a non-superhard phase at least partially filling a plurality of the interstitial regions;
wherein:
the median of the mean free path associated with the non-superhard phase divided by (Q3−Q1) for the non-superhard phase is greater than or equal to 0.50, where Q1 is the first quartile and Q3 is the third quartile of the mean free path measurements associated with the non-superhard phase; and
the median of the mean free path associated with the superhard grains divided by (Q3−Q1) for the superhard grains is less than 0.60, where Q1 is the first quartile and Q3 is the third quartile of the mean free path measurements associated with the superhard grains; and
the method further comprising forming a non-planar surface topology in a first surface of the body of polycrystalline diamond material, the surface topology comprising one or more indentations in and/or projections extending from the first surface.

27. The method of claim 26, wherein, the step of providing a mass of grains of superhard material comprises providing a mass of diamond grains having a first fraction having a first average size and a second fraction having a second average size, the first fraction having an average grain size ranging from about 10 to 60 microns, and the second fraction having an average grain size less than the size of the first fraction.

28.-36. (canceled)

37. The method of claim 27, wherein the average grain sizes of the fractions is separated by an order of magnitude.

38. (canceled)

39. The method of claim 26, wherein the step of forming the surface topology comprises:
placing an aggregated mass of grains of superhard material into a canister;
placing a ceramic layer formed of a ceramic material either in direct contact with the aggregated mass of grains of superhard material, or in indirect contact therewith wherein the ceramic layer is spaced from the grains by an interlayer of material, the ceramic layer having a surface with surface topology, the surface topology imprinting a pattern in the aggregated mass of grains of superhard material complementary to the surface topology, the ceramic material and the material of the interlayer where present being such that they do not react chemically with the superhard material and/or a sinter catalyst material for the grains of superhard material; the method further comprising:
subjecting the aggregated mass of grains of superhard material and ceramic layer to a pressure of greater than around 5.5 GPa in the presence of the sinter catalyst material for the grains of superhard material at a temperature sufficiently high for the catalyst material to melt;
sintering the grains to form a body of polycrystalline superhard material having a surface topology complementary to the surface topology of the ceramic layer; and
removing the ceramic layer and said interlayer if present from the body of polycrystalline material.

40. A method according to claim 39, wherein the step of placing the ceramic layer in contact with the grains of superhard material comprises placing the ceramic material in indirect contact therewith through the interlayer of material, the interlayer comprising a coating on the ceramic layer.

41. (canceled)

42. A method according to claim 39, wherein the step of placing the ceramic material in contact with the grains comprises placing a ceramic material formed of any one or more of the group of oxide ceramic materials that are not reduced by carbo-thermal reaction in contact with the grains.

43. A method according to claim 42, wherein the ceramic material is formed of any one or more of the group of oxide ceramic materials comprising magnesia, calcia, zirconia, and/or alumina.

44.-45. (canceled)

46. A method according to claim 39, wherein step of forming the body of polycrystalline superhard material comprises forming a body having a free outer surface on removal of the ceramic layer therefrom in which the free outer surface is of the same quality as the bulk of the body of polycrystalline superhard material.

47.-51. (canceled)

52. A method as claimed in claim 26, further comprising treating the body of superhard polycrystalline material to remove catalyst material from interstices between inter-bonded grains in the superhard material after sintering.

53.-56. (canceled)
